(19) United States
(12) Patent Application Publication
(10) Pub. No.: US 2011/0273293 A1
(43) Pub. Date: Nov. 10, 2011

(54) LIGHT-CURTAIN ALARM WITH PROXIMITY-DETECTED ACCESS AUTHORIZATION

(75) Inventors: Arnold Itkin, Leominster, MA (US); Douglas P. Burum, Acton, MA (US)

(73) Assignee: Arnold Itkin, Leominster, MA (US)

(21) Appl. No.: 13/100,586

(22) Filed: May 4, 2011

Related U.S. Application Data
(60) Provisional application No. 61/331,098, filed on May 4, 2010.

(51) Int. Cl. G08B 13/18

(52) U.S. Cl. 340/557; 340/556

(57) ABSTRACT

A light-curtain alarm system is disclosed that provides to authorized persons uninhibited access to a protected item by automatically, temporarily deactivating the alarm whenever proximity of an authorized person is detected. Each authorized person carries a deactivating device that is detected at short range, preferably using radio waves or Bluetooth. Embodiments can track detection information, and/or distinguish between a plurality of deactivating devices, so as to track and/or control access to the protected item. The deactivating device can be included in an identification badge, and/or can be carried in a pocket or worn around a wrist or neck. The light-curtain can be generated using any combination of lasers and/or other light sources, light reflectors, and photo-detectors. In preferred embodiments, the alarm system can be configured to control access to a magnet of a magnetic resonance device, such as an MRI or NMR.

### RELATED APPLICATIONS

This application claims the benefit of U.S. Provisional Application No. 61/331,098, filed May 4, 2010. This application is herein incorporated by reference in its entirety for all purposes.

### FIELD OF THE INVENTION

The invention generally relates to alarm systems, and more specifically to light-curtain alarm systems

### BACKGROUND OF THE INVENTION

Many types of alarm system are used to prevent unauthorized and/or unwanted access to items that require protection. Some alarm systems are designed to protect items from damage and/or theft. Other alarm systems are designed to protect unauthorized persons from coming into contact with a protected item that may be dangerous, or may pose certain risks to the health and/or property of the unauthorized person. And still other alarm systems serve both purposes.

Alarm systems generally require a mechanism by which to detect unauthorized intrusion. Many alarm systems are cooperative with physical barriers, such as home alarm systems that are triggered when a window or door is compromised, or museum alarm systems that are triggered when a display case is opened or a painting is moved. Other alarm systems use a non-physical sensor, such as a motion detector, to sense the unauthorized presence of an intruder. Still other alarm systems use a proximity sensor. For example, a so-called “electric fence” limits the movement of a pet by using a device worn by the pet to detect a short-range signal transmitted from an underground wire, and to deliver a harmless electric shock to the pet if the pet approaches too close to the wire.

In circumstances where it is desirable to provide a well defined intrusion barrier without providing a physical barrier, a beam of light is often used as the intruder detecting mechanism. In this approach, the beam of light traverses a space and is detected by a photo-detector. Interruption of the light beam by an intruder is detected by the photo-detector and triggers the alarm. In some alarm systems, a plurality of light sources project beams of light to a plurality of photo-sensors, thereby forming a two-dimensional “light-curtain” barrier. Other alarm systems generate a light-curtain by using a single light source, such as a low-powered LASER, to emit a single beam of light, which is reflected between two boundaries in a zigzag pattern before reaching the photo-detector, thereby forming the light-curtain. In general, any number of light sources, photo-detectors, and light reflectors can be combined in any desired configuration so as to form a light-curtain alarm barrier.

Once an intruder is detected, an alarm system must take some kind of action. A literal alarm may be issued, such as a loud noise and/or a bright, flashing light. A recorded message may be broadcast. Police and/or security personnel may be automatically notified. In cases where dangerous machinery is protected by the alarm system, the machinery may be deactivated. For example, a stamping machine or mechanical press may be prevented from operating if the hand of an operator penetrates a protective light-curtain barrier.

While alarm systems can be highly valuable for protecting property and the safety of personnel, they can be highly inconvenient and burdensome on those who require authorized access to the item(s) being protected. If an alarm system includes physical barriers, these must be opened and shut each time access is required. Even if physical barriers are not used, the alarm system must be deactivated each time access to the protected item(s) is required, and then re-activated each time the access is finished. Often, so as to activate and/or deactivate an alarm system, a key must be inserted into an alarm control unit, a code must be entered into an alarm keypad, and/or a badge with a special magnetic or acoustic strip must be inserted into, or held next to, a special reader. If frequent access to the protected item(s) is required, for example every few minutes, this can prove to be completely impractical, with the result that an authorized user will be strongly tempted to deactivate the alarm system during an entire period of use, such as an entire day. This may result in the alarm system not being active when needed, such as during a lunch or bathroom break, or overnight if the authorized user forgets to reactivate the system at the end of the day.

A particular example of this dilemma is posed by scientific and medical devices that use a technique known as “magnetic resonance.” Such devices include clinical, research, and even veterinary MRI systems, as well as scientific measurement devices called “Nuclear Magnetic Resonance” spectrometers, or “NMR's.” While most clinical MRI systems are installed in dedicated rooms to which physical access can be controlled, many NMR systems, and many research and veterinary MRI systems, share a space that is used for other purposes. In these cases, access to the magnetic resonance device is more difficult to control.

A magnetic resonance device requires the use of a very powerful magnet, which must be left on at all times. The strength of the magnetic field is sufficient to erase credit cards and other magnetic media, and can pose a significant health risk to certain individuals by dislodging ferromagnetic medical implants and/or degrading the functioning of a pacemaker. The magnetic field is also strong enough to pick up a small to mid-sized object, such as a hand-tool or a janitor's bucket, and cause the object to literally fly through the air and into the magnet. This can pose a safety risk to anyone in the path of the flying object, and can also cause damage to the magnet, which may be very expensive and time-consuming to repair.

The strength of a magnetic field can be expressed in units called “Gauss.” The earth's magnetic field, for example, is approximately 0.5 Gauss. The minimum magnetic field strength at which the above-described dangers occur is approximately 5 Gauss. For this reason, a magnetic resonance magnet is said to be surrounded by a “5-Gauss” line that marks the safe approach distance at which the magnetic field surrounding the magnet has a strength of 5 Gauss. When a magnetic resonance system is not located in a dedicated room, there is often a danger that the 5-Gauss line may be breached inadvertently by someone who is not familiar with the inherent dangers of the system, such as a worker using another part of the room, or a janitor cleaning up during lunch or after hours.

Typically, warning signs are posted near a magnetic resonance system, and a line is marked on the ground at the 5-Gauss limit. Often, a removable barrier such as a series of lightweight plastic posts and chains is placed at the 5-Gauss line to serve as a more noticible reminder. However, these precautions can be insufficient, since signs can go unnoticed or be ignored, or can even be unintelligible to some individuals, and the plastic barrier may be left out of place or easily moved aside, for example by a janitor trying to clean the floor near or under the magnet.

It is usually impractical to place an effective physical barrier at the 5-Gauss line of an MRI or NMR magnet. For example, authorized users of an MRI scanner are required to cross the 5-Gauss line every time a patient or other object is scanned, and authorized users of an NMR system are required to cross the 5-Gauss line each time a new sample is inserted for analysis, which can be as often as every few minutes. Also, adjustments near the magnet are sometimes needed so as to calibrate an NMR for a specific measurement, and this can require an authorized user to perform work within the 5-Gauss line. A physical barrier that was not easily moved aside would therefore be unreasonably inconvenient and burdensome to authorized users of an MRI or an NMR.

Installation of a light-curtain or other form of alarm system at the 5-Gauss line would be similarly inconvenient and burdensome to authorized users, who would need to deactivate and then reactivate the alarm every few minutes, and would be highly tempted to simply leave it switched off.

### SUMMARY OF THE INVENTION

A light-curtain alarm system is claimed that can surround a protected item with a well defined alarm barrier, while providing uninhibited access to authorized persons by automatically deactivating the alarm whenever proximity of an authorized person is detected. Each authorized person wears or carries a deactivating device that is detected at short range by a proximity detector included with the alarm system. When the authorized person is near the light-curtain, proximity of the deactivating device is detected, and the alarm is deactivated. Once the authorized person has moved away from the light-curtain, the deactivating device is no longer detected, and the alarm system is automatically reactivated. Uninhibited access to the protected item is thereby provided to authorized persons, without any need to manually deactivate and reactive the alarm system each time access is required.

In preferred embodiments, the deactivating device is detected by the proximity detector using radio waves, in a manner that is similar to the proximity detecting technology used by an electronic pet fence. In other embodiments, the deactivating device is detected by the proximity detector using Bluetooth technology.

In some preferred embodiments, the proximity detector can distinguish between each of a plurality of deactivating devices, which can be issued to a plurality of authorized personnel. This allows the alarm system in some embodiments to record information regarding which personnel have been granted access to a protected item, and/or when the access was granted.

The deactivating device can be carried in a pocket or worn by a strap around a wrist or around the neck of an authorized user. In preferred embodiments, the deactivating device is included in an identification badge, which can also be used to gain access to a building and/or to specified rooms within a building. The light-curtain can be generated by any combination of LASERS and other light sources, reflectors, and photo-detectors, according to methods and technology well known in the art.

In certain preferred embodiments, the light-curtain alarm system of the present invention is used to inhibit unauthorized access to a magnet of a magnetic resonance system, such as an NMR or MRI. A light-curtain is positioned at or near the 5-Gauss line surrounding the magnet, and an audible and/or visible alarm is triggered if an unauthorized person penetrates the light-curtain. Authorized users of the NMR or MRI wear or carry deactivation devices that allow them to approach the NMR or MRI magnet without triggering the alarm, and without any need to manually deactivate and reactivate the alarm system each time access to the magnet is required. In preferred embodiments, at least one LASER source and at least one light detector are positioned above the floor, preferably in the ceiling, and reflective material is attached to the floor and ceiling. LASER light from the source is repeatedly reflected between the reflective materials on the floor and ceiling, before reaching the light detector, thereby creating a light-curtain with virtually no physical impact on the floor, and no consequent tripping hazard.

One general aspect of the present invention is a light-curtain alarm system for protecting an item while allowing uninhibited access to an authorized person by automatic alarm deactivation when proximity of the authorized person is detected. The light-curtain alarm system includes a light-curtain generator that is able to generate a light-curtain using at least one included light source and at least one included light detector, an alarm controller cooperative with the light-curtain generator and able to initiate a reactive action when the light-curtain is penetrated, a proximity detector cooperative with the alarm controller and able to prevent initiation of the reactive action when a proximity of the authorized person is detected, and at least one deactivating device that can be carried by the authorized person, the at least one deactivating device being wirelessly detectable by the proximity detector, so as to enable the proximity detector to detect the proximity of the authorized person.

In various embodiments, at least one of the light sources is a LASER. In certain embodiments the light-curtain generator includes at least one light reflector.

In some embodiments the reactive action is at least one of broadcasting an audible signal, displaying a visible signal, broadcasting a verbal message, transmitting a message to a law enforcement representative, transmitting a message to a security-responsible person, transmitting a message to a person associated with an item protected by the light-curtain alarm system, securing a physical barrier, and deactivating a protected item.

In various embodiments the proximity detector is able to detect the deactivating device by one of radio communication, and Bluetooth communication.

In certain embodiments the proximity detector is able to distinguish between a plurality of deactivating devices, so as to determine which of the plurality of deactivating devices has been detected. In some of these embodiments the proximity detector can be configured to deactivate the alarm controller only upon detection of a member of a specified subset of the plurality of deactivating devices.

Some embodiments further include a tracking recorder that is able to record information pertaining to detection of deactivating devices by the proximity detector.

In other embodiments the deactivating device is configured so as to be at least one of carriable in a pocket of a user wearable around a neck of a user and attachable to a limb of a user.

And in certain embodiments the deactivating device is incorporated into an identification badge.

Another general aspect of the present invention is a magnetic resonance light-curtain alarm system for protecting a magnet included in a magnetic resonance device, the magnetic resonance alarm system providing uninhibited magnet access to an authorized person by automatic alarm deactivation when proximity of the authorized person is detected. The magnetic resonance light-curtain alarm system includes a light-curtain generator, including at least one light source and at least one light detector, the light-curtain generator being able to generate a light-curtain that surrounds at least a portion of the magnet, so as to be penetrated by an unauthorized person approaching the magnet. The magnetic resonance alarm system further includes an alarm controller, cooperative with the light-curtain generator and able produce a perceptible alarm signal when the light-curtain is penetrated, a proximity detector, cooperative with the alarm controller and able to prevent the producing of the perceptible alarm signal when a proximity of the authorized person is detected, and at least one deactivating device that can be carried by the authorized person, the at least one deactivating device being wirelessly detectable by the proximity detector, so as to enable the proximity detector to detect the proximity of the authorized person.

In various embodiments the light-curtain generator includes at least one laser that can be mounted above a floor, and at least one light reflector that can be attached to the floor. In some of these embodiments the at least one light reflector is a low profile light reflector that can be attached to the floor without penetrating the floor, and without creating a tripping hazard on the floor.

In certain embodiments the perceptible alarm signal includes at least one of an audible sound, a visible light, and a broadcasted verbal message.

In some embodiments the proximity detector is able to detect the deactivating device by one of radio communication and Bluetooth communication.

In other embodiments the proximity detector is able to distinguish between a plurality of deactivating devices, so as to determine which of the plurality of deactivating devices has been detected. In some of these embodiments the proximity detector can be configured to prevent the producing of the perceptible alarm signal only upon detection of a member of a specified subset of the plurality of deactivating devices.

Various embodiments further include a tracking recorder that is able to record information pertaining to detection of deactivating devices by the proximity detector.

In certain embodiments the deactivating device is configured so as to be at least one of carriable in a pocket of a user, wearable around a neck of a user, and attachable to a limb of a user.

And in other embodiments the deactivating device is incorporated into an identification badge.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention will be more fully understood by reference to the detailed description, in conjunction with the following figures, wherein:

FIG. 1 is a block diagram of the present invention;

FIG. 2A illustrates the structure of a light-curtain formed by beams of light transmitted directly from a plurality of light sources to a plurality of light detectors;

FIG. 2B illustrates the structure of a light-curtain formed by beams of light transmitted from a plurality of light sources and reflected from reflective surfaces to a plurality of light detectors;

FIG. 2C illustrates the structure of a light-curtain formed by a single beam of light transmitted by a single light source and repeatedly reflected between two reflective surfaces before reaching a single light detector;

FIG. 3A is a perspective view of a typical NMR spectrometer, including prior art magnet protection consisting of warning signs posted on the walls and a line marked on the floor that indicates the location of the 5-Gauss line;

FIG. 3B is a perspective view of the NMR spectrometer of FIG. 3A, wherein a janitor with a mop and a pail has approached too close to the magnet while cleaning the floor;

FIG. 3C is a perspective view of the NMR spectrometer of FIG. 3A, wherein the pail has been drawn against the magnet due to the strong magnetic field of the magnet, thereby damaging the magnet;

FIG. 3D is a perspective view of the NMR spectrometer of FIG. 3A, further including prior art magnet protection consisting of a lightweight plastic chain suspended at the 5-Gauss line by lightweight plastic posts;

FIG. 3E is a perspective view of the NMR spectrometer of FIG. 3A, wherein an embodiment of the light-curtain alarm system of the present invention has been installed, with a light-curtain located at the 5-Gauss line;

FIG. 3F is a perspective view of the NMR spectrometer of FIG. 3E, wherein the light-curtain has been automatically switched off due to detection of a deactivating device worn by an authorized user of the NMR spectrometer;

FIG. 4 is a block diagram of an embodiment of the present invention that includes a tracking recorder for tracking the detection of deactivating devices;

FIG. 5A is a perspective view of a preferred embodiment deactivating device that is included in an identification badge and suspendable by a cord from a user's neck; and

FIG. 5B is a perspective view of a preferred embodiment deactivating device that is attachable by a strap to a user's arm or leg.

### DETAILED DESCRIPTION OF PREFERRED EMBODIMENTS

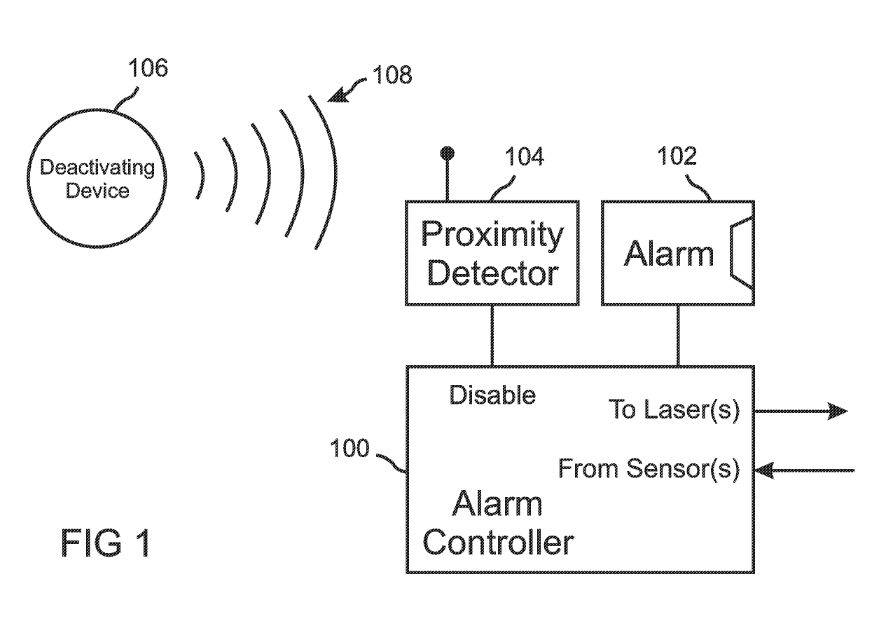

With reference to FIG. 1, the present invention is an alarm system that includes a light-curtain generator (not shown) controlled by an alarm controller 100. The light-curtain generator is configurable so as to generate a light-curtain that surrounds a protected item, so that the item cannot be easily reached without penetrating the light-curtain. The alarm controller 100 includes an alarm unit 102 that is able to initiate a reactive action if the light-curtain is penetrated while the alarm system is active. In preferred embodiments, the reactive action can include sounding an audible alarm, switching on bright, flashing lights, broadcasting a recorded message, calling police and/or security personnel, and/or locking a container that physically protects the protected item.

The alarm system of the present invention further includes a proximity detector 104 that can wirelessly detect at least one deactivating device 106 when the deactivating device 106 is near the proximity detector 104. In various preferred embodiments, the deactivating device 106 is detected by the proximity detector 104 using low power radio waves, in a manner similar to the proximity detection technology commonly used in electronic pet fences. In other embodiments, the deactivating device 106 is detected by the proximity detector 104 using Bluetooth technology. Depending on the embodiment, the deactivating device 106 is only detected when it is within a certain distance of the proximity detector 104, preferably when it is within a few feet of the proximity detector 104. This allows an authorized person who is carrying or wearing the deactivating device to have repeated and unobstructed access to the protected device, without danger of the alarm system being left in an inactive state when the authorized person leaves the area.

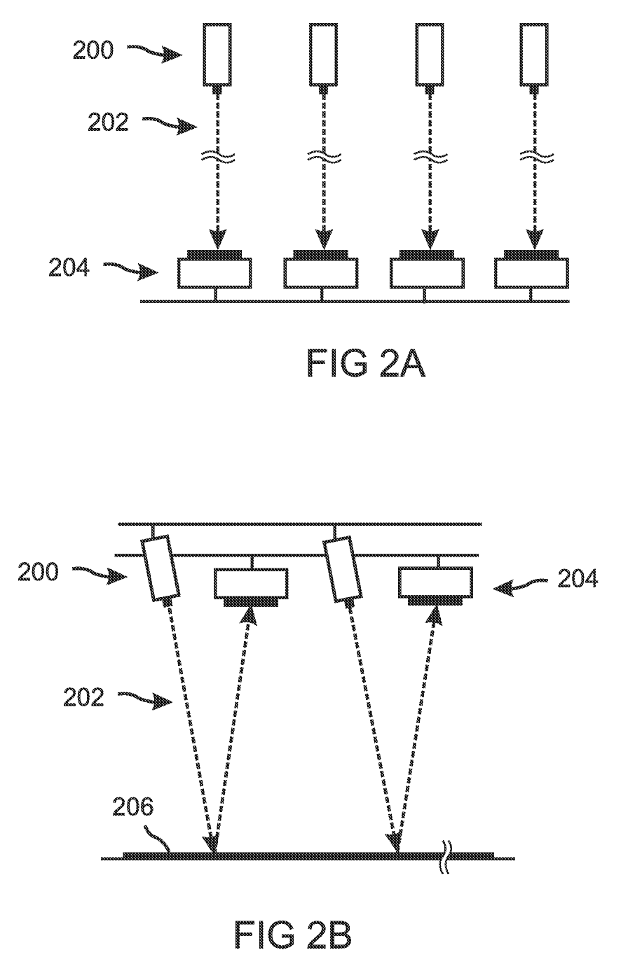

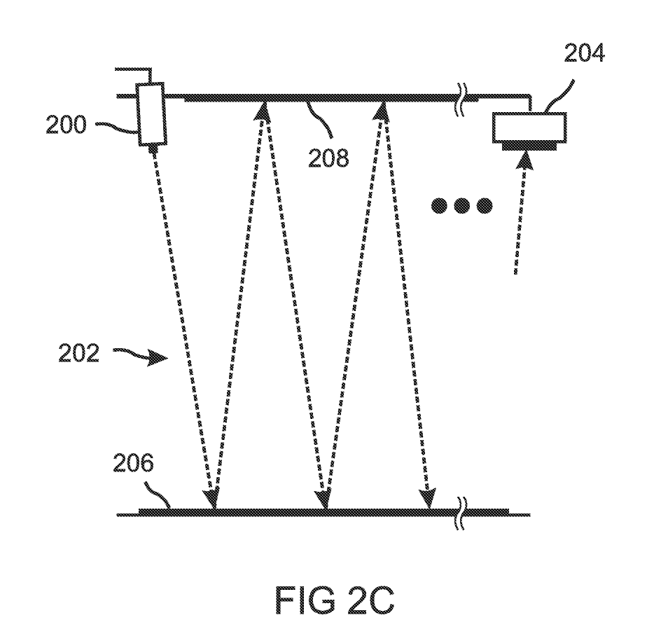

FIG. 2A illustrates a light-curtain generator of a preferred embodiment. In this embodiment, a plurality of light sources 200, which in some embodiments are lasers, is arranged so as to direct a plurality of parallel light beams 202 toward a plurality of light detectors 204. If any of the light detectors 204 fails to detect a beam of light while the alarm is active, a signal is transmitted to the alarm controller and the reactive action of the alarm unit 102 is triggered.

FIG. 2B illustrates an embodiment similar to FIG. 2A, except that the light sources 200 and light detectors 204 are arranged alternately next to each other. In this embodiment, the light sources 200 direct light beams 202 toward a reflective surface 206, from which they are reflected back to the light detectors 204.

FIG. 2C illustrates an embodiment of a light-curtain generator that requires only one light source 200 and one light detector 204. In this embodiment, the light source 200 is a LASER that directs a laser beam 202 at an angle toward a reflective surface 206. A second reflective surface 208 is located next to the laser 200, and the laser beam 202 is repeatedly reflected between the two reflective surfaces 206, 208 until it reaches a light detector 204. Penetration of the light-curtain at any point interrupts the beam 202 and triggers the alarm.

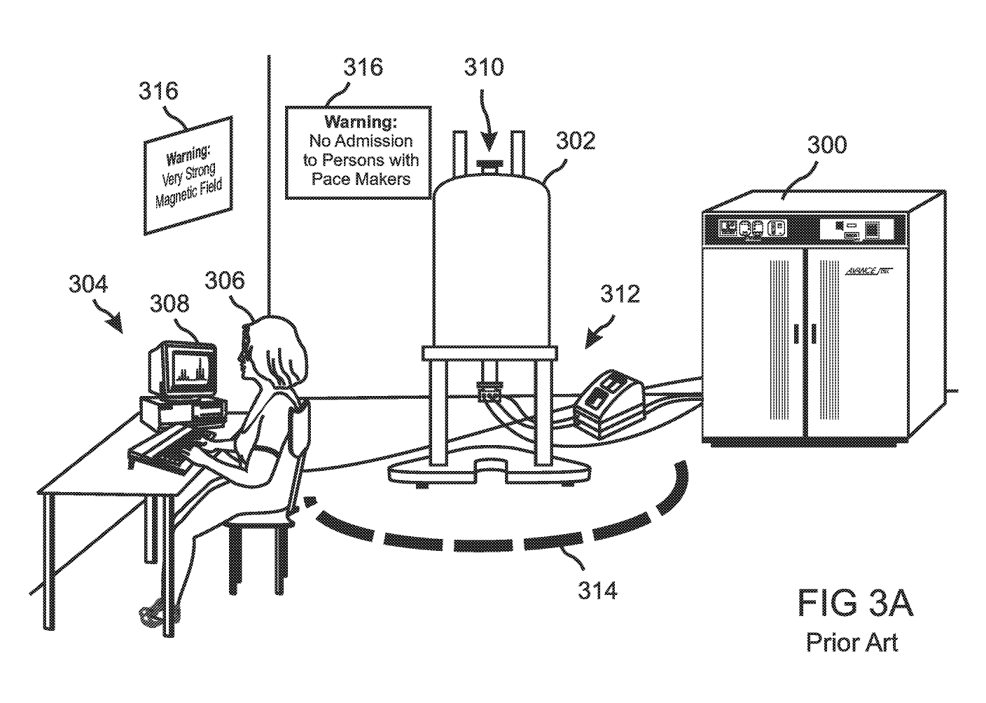

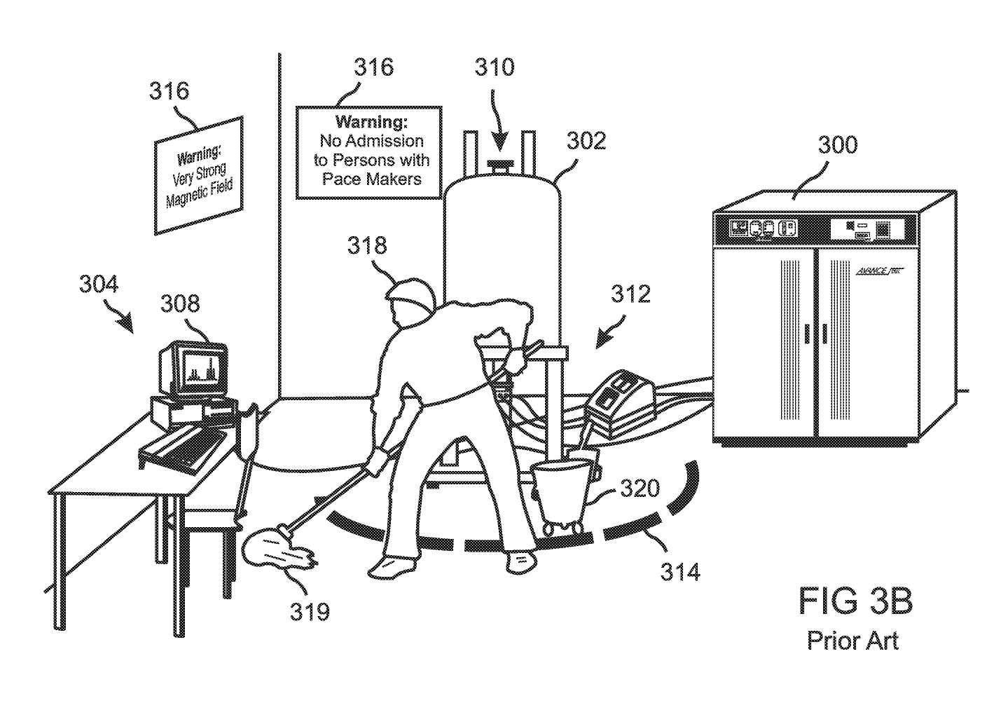

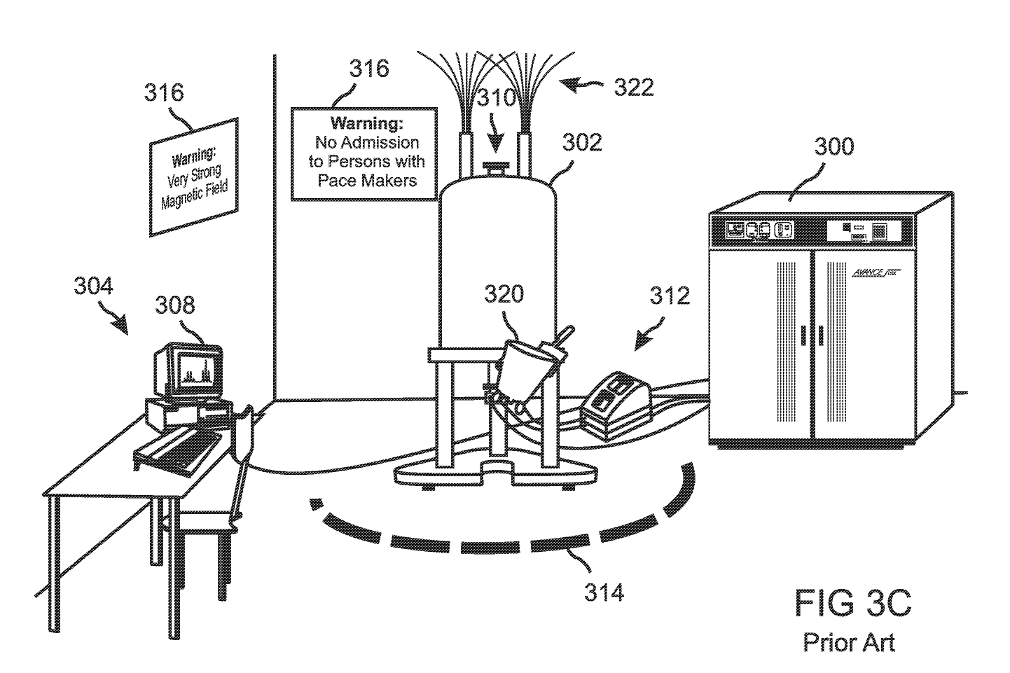

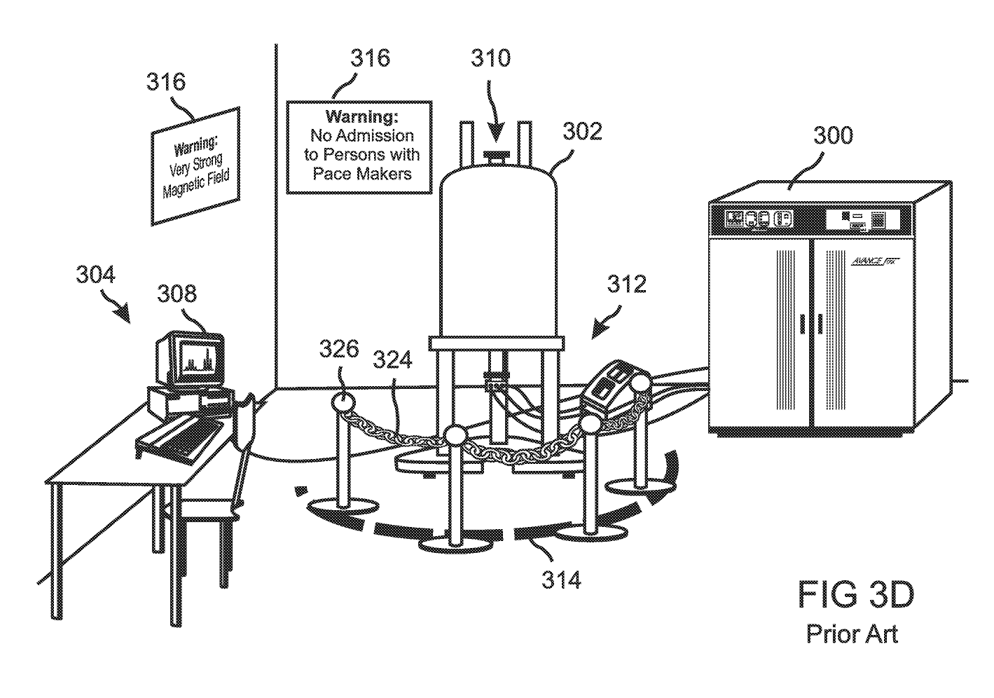

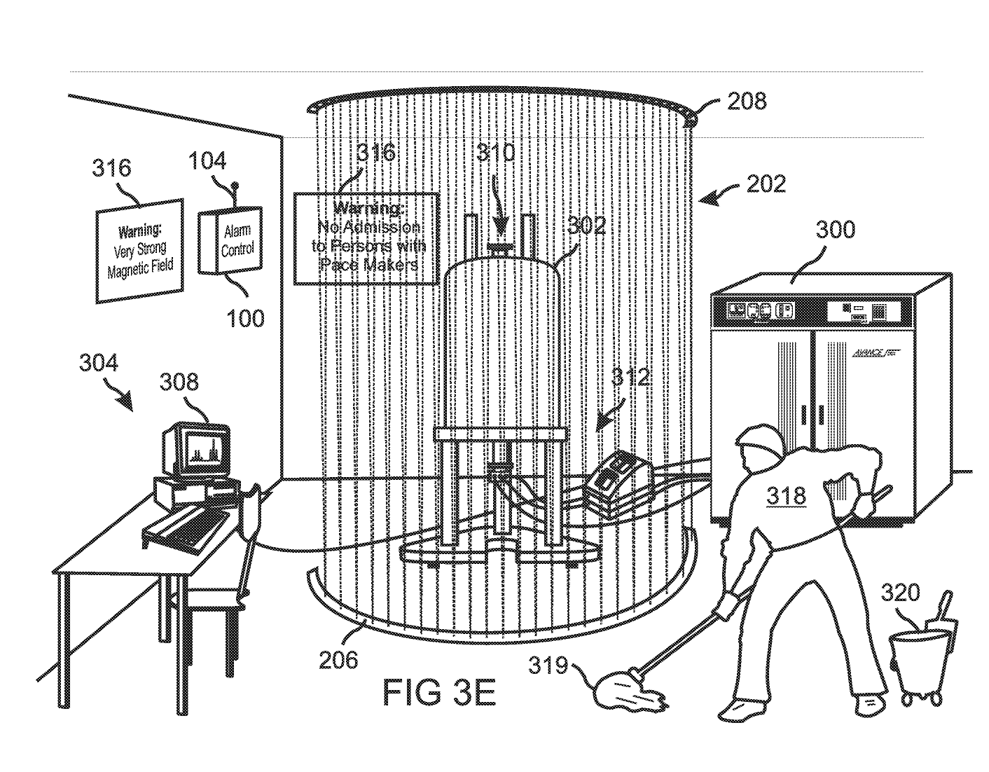

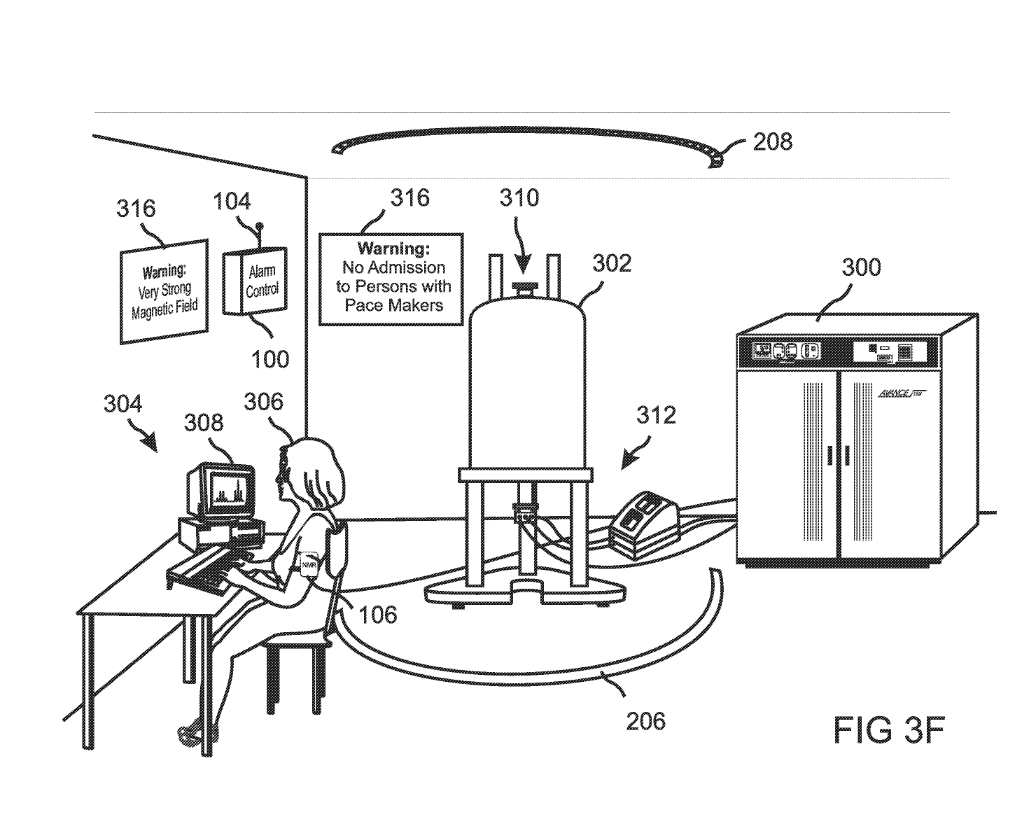

FIG. 3A is a perspective view of a typical NMR spectrometer. The NMR spectrometer includes an electronic console 300, a powerful magnet 302, and an operator's station 304 at which an operator 306 sits and controls the NMR spectrometer using a control computer 308. In FIG. 3A, the magnet 302 is a cryogenic magnet that is cooled by liquefied helium contained within a vacuum-insulated container.

While very powerful, the magnet 302 is also very fragile, and can easily be damaged if it is allowed to capture a chair, wrench, bucket, or other magnetically attracted object that is brought too close to the magnet 302. The magnet 302 can also be dangerous to the safety and possessions of untrained personnel who approach the magnet 302. Dangers include erasure of credit cards and other magnetic media, injury to bystanders due to flying objects attracted to the magnet 302, dislodging of medical implants that are ferromagnetic, and interference with the functioning of pace makers and/or other implanted medical devices.

For all of these reasons, it is highly important to prevent untrained, unauthorized persons from approaching too close to the magnet 302. On the other hand, frequent access to the magnet 302 is required by authorized personnel 306. At the beginning of each analysis, a sample must be inserted into the top of the magnet 310. Also, controls located near the base of the magnet 312 require frequent calibration and adjustment. Depending on the type of analysis being performed, access to the magnet 302 by authorized personnel 306 can be required every few minutes during normal operation. It is therefore not practical to surround the magnet 302 with a secure physical barrier, since this would be highly inconvenient for authorized persons while operating the NMR spectrometer. Similarly, a conventional alarm system is not practical, since it would need to be deactivated and reactivated too frequently.

FIG. 3A illustrates two prior art methods frequently used to protect an NMR magnet. The location of the 5-Gauss safety limit has been marked on the floor 314, and warning signs 316 have been posted on the walls. While these are useful steps, they are insufficient to protect the magnet from unauthorized access, since unauthorized persons may not understand the meaning of the line 314 on the floor, and may not notice, or may not be able to comprehend, the warning signs 316.

In FIG. 3B, a janitor 318 has approached the NMR spectrometer of FIG. 3A so as to clean the surrounding floor with a mop 319 and a pail 320. Without realizing the danger, the janitor 318 has allowed the pail 320 to stray inside of the 5-Gauss line 314 of the magnet 302. FIG. 3C illustrates the result. The pail 320 has been pulled against the magnet 302, the magnet 302 has been damaged, causing the liquefied helium 322 to rapidly boil away in a so-called “quench,” and the janitor 318 has fled. The result will be a very costly and time-consuming repair, so as to return the NMR spectrometer to service.

FIG. 3D illustrates another prior art method of protecting the magnet 302. A lightweight plastic chain 324 has been suspended above the 5-Gauss line 314 by lightweight plastic posts 326. While this approach can serve as a useful reminder to trained personnel who understand it's significance, it is so lightweight and easily moved that an unauthorized person may assume that it is unimportant and may ignore it. A janitor 312, for example, may believe that it is permissible to reach past the plastic chain 324 with a mop 319 so as to clean the floor under the magnet 302. In addition, trained personnel, after moving the plastic chain out of the way while using the system, may forget to put the plastic chain back in position when they leave.

FIG. 3E is a perspective view of a preferred embodiment of the present invention that has been configured so as to protect the magnet 302 of the NMR spectrometer of FIG. 3A. A light-curtain generator 206, 208 under control of an alarm controller 100 establishes a light-curtain 202 that surrounds a portion of the magnet 302 at the 5-Gauss line 302. The light-curtain generator 206, 208 of FIG. 3E is similar in design to FIG. 2C. Reflective strips are installed on the floor 206 and on the false ceiling, and a single laser light source installed above the false ceiling (not shown) generates a beam of light 202 that is repeatedly reflected between the two reflective surfaces 206, 208 until it reaches a light detector which is also installed in the false ceiling (not shown). When the alarm is active, any penetration of the light-curtain 202 will immediately trigger a loud, audible alarm. In some embodiments, a recorded message will also be broadcast.

FIG. 3F is a perspective view of the embodiment of FIG. 3E, in which the alarm system has been automatically deactivated due to detection by the proximity detector 104 of a deactivating device 106 worn by a nearby authorized person 306. In FIG. 3F, the deactivating device 106 is included in an identification badge 106 that is attached by a band to an arm of the authorized person 306.

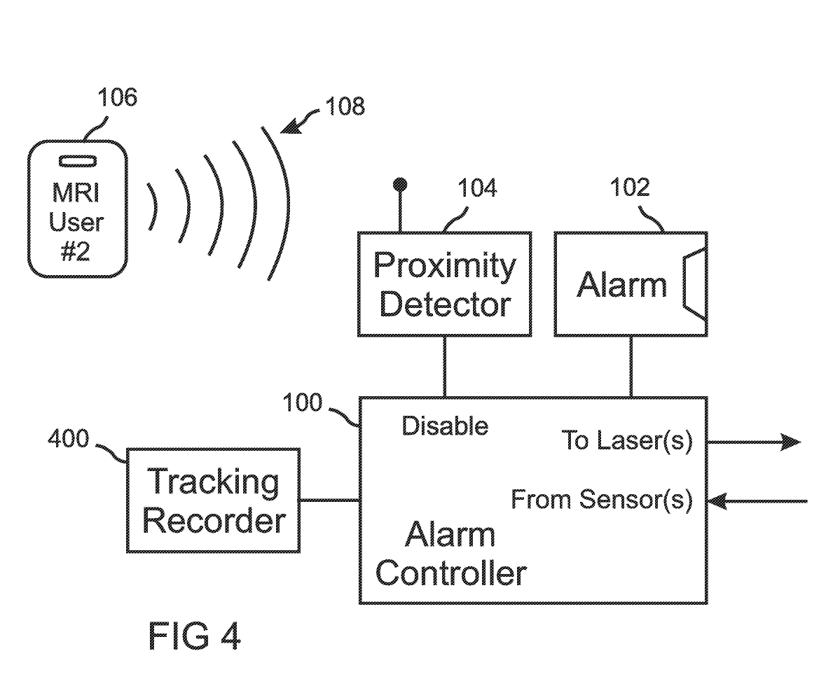

A block diagram of the embodiment of FIG. 3F is presented in FIG. 4. In this embodiment, the proximity detector 104 detects the deactivation device 106 using Bluetooth technology 108, and is thereby able to distinguish between each of a plurality of deactivation devices 106 that may be provided to each of a plurality of authorized persons. The embodiment further includes a tracking recorder 400 that is able to record information pertaining to detection of deactivating devices by the proximity detector. This information can be used, for example, to track usage of an NMR or MRI system by different members of an authorized user group, and/or to flexibly control the granting of access to specific members of the group at different times. In similar embodiments where the proximity detector does not distinguish between deactivating devices, the tracking recorder can be used to record overall usage patterns for the NMR or MRI system.

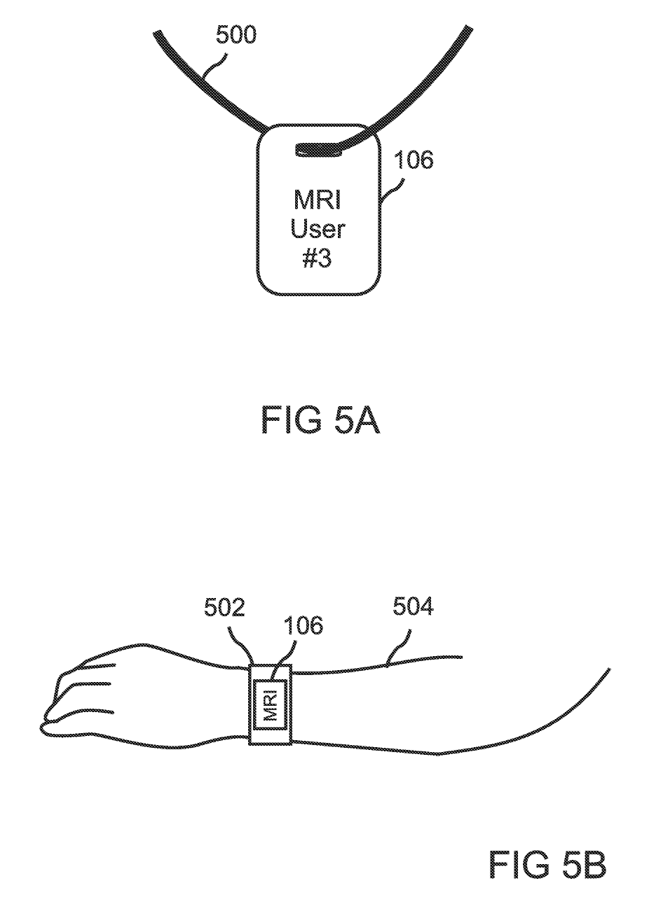

As is illustrated in FIG. 5A and FIG. 5B, in various embodiments the deactivating device is included in a badge 106 that is carried in a pocket (not shown), worn about the neck using a cord or ribbon 500, or attached by a strap 502 to a limb 504 of an authorized user.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A light-curtain alarm system for protecting an item while allowing uninhibited access to an authorized person by automatic alarm deactivation when proximity of the authorized person is detected, the light-curtain alarm system comprising:
a light-curtain generator that is able to generate a light-curtain using at least one included light source and at least one included light detector;
an alarm controller cooperative with the light-curtain generator and able to initiate a reactive action when the light-curtain is penetrated;
a proximity detector cooperative with the alarm controller and able to prevent initiation of the reactive action when a proximity of the authorized person is detected; and
at least one deactivating device that can be carried by the authorized person, the at least one deactivating device being wirelessly detectable by the proximity detector, so as to enable the proximity detector to detect the proximity of the authorized person.

2. The light-curtain alarm system of claim 1, wherein at least one of the light sources is a LASER.

3. The light-curtain alarm system of claim 1, wherein the light-curtain generator includes at least one light reflector.

4. The light-curtain alarm system of claim 1, wherein the reactive action is at least one of:
broadcasting an audible signal;
displaying a visible signal;
broadcasting a verbal message;
transmitting a message to a law enforcement representative;
transmitting a message to a security-responsible person;
transmitting a message to a person associated with an item protected by the light-curtain alarm system;
securing a physical barrier; and
deactivating a protected item.

5. The light-curtain alarm system of claim 1, wherein the proximity detector is able to detect the deactivating device by one of:
radio communication; and
Bluetooth communication.

6. The light-curtain alarm system of claim 1, wherein the proximity detector is able to distinguish between a plurality of deactivating devices, so as to determine which of the plurality of deactivating devices has been detected.

7. The light-curtain alarm system of claim 6, wherein the proximity detector can be configured to deactivate the alarm controller only upon detection of a member of a specified subset of the plurality of deactivating devices.

8. The light-curtain alarm system of claim 1, further comprising a tracking recorder that is able to record information pertaining to detection of deactivating devices by the proximity detector.

9. The light-curtain alarm system of claim 1, wherein the deactivating device is configured so as to be at least one of:
carriable in a pocket of a user;
wearable around a neck of a user; and
attachable to a limb of a user.

10. The light-curtain alarm system of claim 1, wherein the deactivating device is incorporated into an identification badge.

11. A magnetic resonance light-curtain alarm system for protecting a magnet included in a magnetic resonance device, the magnetic resonance alarm system providing uninhibited magnet access to an authorized person by automatic alarm deactivation when proximity of the authorized person is detected, the magnetic resonance light-curtain alarm system comprising:
a light-curtain generator, including at least one light source and at least one light detector, the light-curtain generator being able to generate a light-curtain that surrounds at least a portion of the magnet, so as to be penetrated by an unauthorized person approaching the magnet;
an alarm controller, cooperative with the light-curtain generator and able produce a perceptible alarm signal when the light-curtain is penetrated;
a proximity detector, cooperative with the alarm controller and able to prevent the producing of the perceptible alarm signal when a proximity of the authorized person is detected; and
at least one deactivating device that can be carried by the authorized person, the at least one deactivating device being wirelessly detectable by the proximity detector, so as to enable the proximity detector to detect the proximity of the authorized person.

12. The magnetic resonance light-curtain alarm system of claim 11 wherein the light-curtain generator includes at least one laser that can be mounted above a floor, and at least one light reflector that can be attached to the floor.

13. The magnetic resonance light-curtain alarm system of claim 12 wherein the at least one light reflector is a low profile light reflector that can be attached to the floor without penetrating the floor, and without creating a tripping hazard on the floor.

14. The magnetic resonance light-curtain alarm system of claim 11, wherein the perceptible alarm signal includes at least one of:
an audible sound;
a visible light; and
a broadcasted verbal message.

15. The magnetic resonance light-curtain alarm system of claim 11, wherein the proximity detector is able to detect the deactivating device by one of:
radio communication; and
Bluetooth communication.

16. The magnetic resonance light-curtain alarm system of claim 11, wherein the proximity detector is able to distinguish between a plurality of deactivating devices, so as to determine which of the plurality of deactivating devices has been detected.

17. The magnetic resonance light-curtain alarm system of claim 16, wherein the proximity detector can be configured to prevent the producing of the perceptible alarm signal only upon detection of a member of a specified subset of the plurality of deactivating devices.

18. The magnetic resonance light-curtain alarm system of claim 11, further comprising a tracking recorder that is able to record information pertaining to detection of deactivating devices by the proximity detector.

19. The magnetic resonance light-curtain alarm system of claim 11, wherein the deactivating device is configured so as to be at least one of:
carriable in a pocket of a user;
wearable around a neck of a user; and
attachable to a limb of a user.

20. The magnetic resonance light-curtain alarm system of claim 11, wherein the deactivating device is incorporated into an identification badge.
